(19) United States
(12) Patent Application Publication
(10) Pub. No.: US 2009/0184506 A1
(43) Pub. Date: Jul. 23, 2009

(54) FLEXURAL MOUNT DEVICE, AND ASSEMBLY AND VEHICLE COMPRISING SAME

(76) Inventors: Samuel Hughes, Martin, KY (US); Alan Cruickshank, Raleigh, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 12/017,809

(22) Filed: Jan. 22, 2008

(51) Int. Cl. F16B 1/00; F16M 13/04; B60R 11/00

(52) U.S. Cl. 280/756; 403/6; 248/544; 280/727

(57) ABSTRACT

A flexural mount device for securing a mountable structure to a base structure, comprising a main body portion of first thickness, with front and back surfaces, an intermediate portion with front and back surfaces, wherein the intermediate portion back surface is substantially coplanar with and extends from the back surface of the main body portion, and an end portion with front and back surfaces, the end portion back surface being substantially coplanar with and extending from the back surface of the intermediate portion, the intermediate and end portions having a second thickness smaller than the first thickness, the intermediate portion being sufficiently flexible so that the end portion can be folded back toward the main body portion so that the intermediate portion has an arcuate profile for corresponding circumferential contact with the base structure, the intermediate and end portions including an elongate channel opening therein and the main body portion being adapted for fastening of the mountable structure with a fastener assembly engaging the main body portion and the elongate channel opening. A mounting assembly including the flexural mount device may be employed in a vehicle to secure a mountable structure to the vehicle.

### BACKGROUND OF THE INVENTION

1. Field of the Invention

The present invention relates to a flexural mount device that is useful to quickly and efficiently secure an article to a base structure, e.g., a tubular roll cage of a recreational vehicle, as well as to assemblies comprising such flexural mount device. In one implementation, the invention relates to a recreational vehicle including a foldable windshield provided with a flexural mount to quickly and efficiently secure the windshield or a like element to a tubular roll cage of the vehicle.

2. Description of the Related Art

In the recreational vehicles industry, a wide variety of two-wheeled and four-wheeled vehicles have been commercialized. One widely commercialized vehicle of the four-wheeled type is the Yamaha Rhino, commercially available from Yamaha Motor Corporation in various models, including the Rhino 660 4×4 model. Other commercially available recreational vehicles of such four-wheeled type, including utility all-terrain vehicles, and side-by-side models, include the Polaris Ranger, commercially available from Polaris Industries, Inc. and the Arctic Cat Prowler commercially available from Arctic Cat Inc.

Various after-market accessories are generally available for recreational vehicles of such type, including customization kits commercialized by various manufacturers.

In the design, manufacture and commercialization of such after-market accessory products, it is necessary to address utilitarian as well as safety aspects of the vehicle that is being modified by the after-market accessories.

Recreational vehicles in many cases are originally manufactured with open passenger compartments, and when such vehicles are used for cross-country or forested terrain travel, the drivers as well as passengers in such recreational vehicles are exposed to the elements, including for example dirt, gravel, rocks, debris, branches, etc., as the vehicle is driven in various off-road locations. Recreational vehicle after-market accessories therefore should be structurally robust and adaptable to such diverse terrain conditions. There is also a significant need for accessories that enhance the safety and comfort of persons traveling in such recreational vehicles.

Recreational vehicles of the above-discussed types are fabricated with a roll cage including tubular structural members to which vehicle accessories and structural components may be affixed in the use and adaptation of such vehicle for specific terrain travel, or to otherwise vary the configuration and/or componentry of the vehicle. The roll cage tubular members may correspondingly be formed with specific clips, fasteners, and other adaptive structures facilitating the accessorizing or conversion of the vehicle. For example, the roll cage may be formed with mounting or affixation structure for securing spotlights, detachable or foldable windshields, racks, cases, toolboxes, canopies, water containers, ice chests, boom boxes, and a wide variety of other articles and objects to the roll cage. It would therefore be advantageous to provide a securement device that is useful, simple and inexpensive, for mounting such articles and objects to the roll cage, in a readily attachable and detachable manner.

### SUMMARY OF THE INVENTION

The present invention relates to a flexural mount device that is useful to quickly and efficiently secure an article to a base structure, such as a strut, spar, beam or the like. The invention also relates to a mounting assembly including the flexural mount device, and in one embodiment to a recreational vehicle in which such flexural mount device is used to secure a structural article to the roll cage of the vehicle.

In one aspect, the invention relates to a flexural mount device for securing a mountable structure to a base structure, in which the flexural mount device comprises a main body portion of first thickness, with front and back surfaces, an intermediate portion with front and back surfaces, wherein the intermediate portion back surface is substantially coplanar with and extends from the back surface of the main body portion, and an end portion with front and back surfaces, the end portion back surface being substantially coplanar with and extending from the back surface of the intermediate portion, the intermediate and end portions having a second thickness smaller than the first thickness, the intermediate portion being sufficiently flexible so that the end portion can be folded back toward the main body portion so that the intermediate portion has an arcuate profile for corresponding circumferential contact with the base structure, the intermediate and end portions including an elongate channel opening therein and the main body portion being adapted for fastening of the mountable structure with a fastener assembly engaging the main body portion and the elongate channel opening.

The invention in another aspect relates to a mounting assembly including a flexural mount device of the above-described type, and a mounting bracket securable to the main body portion of the flexural mount device, in which the mounting bracket includes an extension element that is engageable with the elongate channel opening of the flexural mount device.

A further aspect of the invention relates to a recreational vehicle including a flexural mount device as described above, wherein the flexural mount device secures a structural article to a roll cage of the vehicle.

Other aspects, features and embodiments of the invention will be more fully apparent from the ensuing disclosure and appended claims.

### BRIEF DESCRIPTION OF THE DRAWINGS

FIG. 1 is a perspective view of a two-seat, four-wheeled recreational vehicle, utilizing the flexural mount device of the present invention to secure a foldable windshield in place on the roll cage of the vehicle.

FIG. 2 is an enlarged perspective view of the flexural mount of the invention as depicted in the circle 2 of FIG. 1.

FIG. 3 is a perspective view of the flexural mount device shown in FIG. 2.

FIG. 4 is a front view in elevation of the mount device of FIG. 1.

FIG. 5 is a bottom plan view of the mount device of FIG. 4.

FIG. 6 is a top plan view of the mount device of FIGS. 3, 4 and 5, as folded to a securing position.

FIG. 7 is a perspective view of a mounting assembly including the mount device of FIG. 2, and a bracket coupled to the mount device, for securing to a base structure.

FIG. 8 is a front view in elevation of the bracket shown in FIG. 7.

FIG. 9 is a side view in elevation of the bracket of FIG. 8.

### DETAILED DESCRIPTION OF THE INVENTION, AND PREFERRED EMBODIMENTS THEREOF

The present invention relates to a flexural mount device that is useful to quickly and efficiently secure an article to a base structure, as well as to mount assemblies comprising such flexural mount device, and to vehicles including such flexural mount device.

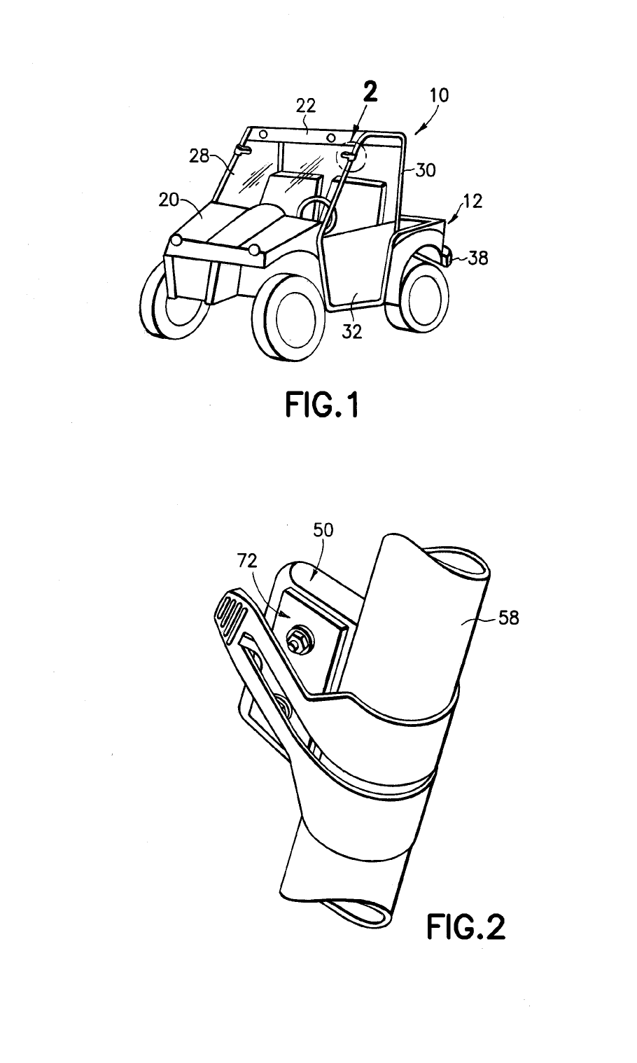

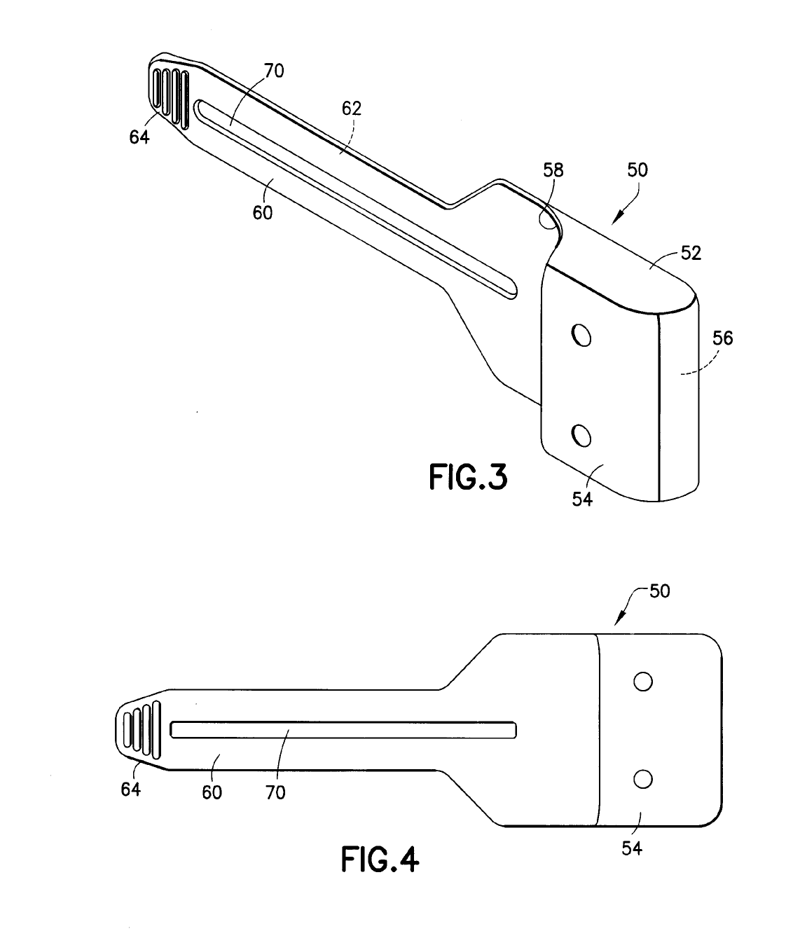

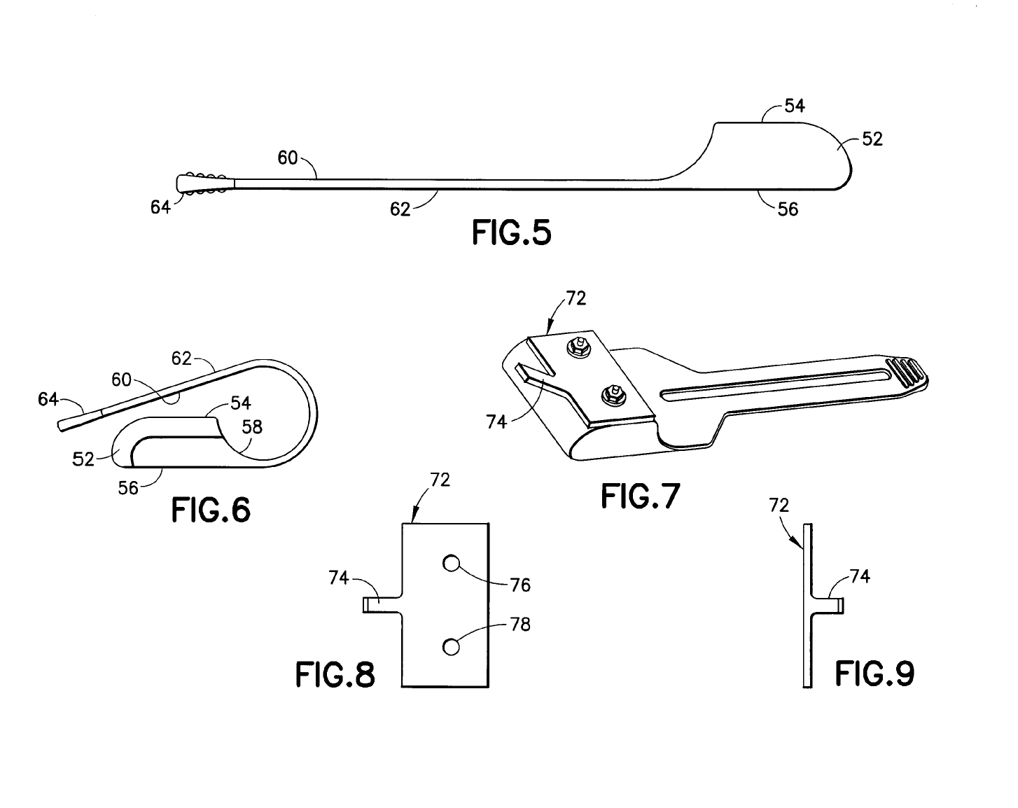

Referring now to the drawings, FIG. 1 is a perspective view of a two-seat, four-wheeled recreational vehicle 10, utilizing the flexural mount device of the present invention (shown in FIG. 1 in the circle 2, and shown in enlarged view in FIG. 2, with various view of the parts thereof shown in the subsequent drawings of FIGS. 3-9).

In the embodiment shown in FIG. 1, the flexural mount device is used to secure a windshield 28 in place on the roll cage of the vehicle. The vehicle 10 can be of any suitable type, such as the aforementioned Yamaha Rhino, commercially available from Yamaha Motor Corporation, the Polaris Ranger, commercially available from Polaris Industries, Inc. or the Arctic Cat Prowler, commercially available from Arctic Cat Inc. In a preferred embodiment, the recreational vehicle is a Yamaha Rhino vehicle.

The vehicle 10 as shown in FIG. 1 includes a roll cage 30 that circumscribes the interior vehicular compartment containing driver and passenger seat components. The chassis 12 has the vehicle body mounted thereon. The vehicle includes a hood 20 on which retention elements can be provided to accommodate fold-down of the windshield 28, when the windshield is of a foldable character. The windshield is secured to the front struts of the roll cage 30 by mounting assemblies of the invention, shown in FIG. 2 in enlarged view with respect to the mounting assembly at the right-hand portion of the windshield of the vehicle shown in FIG. 1.

By means of the mounting assemblies, the windshield can be securely maintained in position spanning the front struts of the roll cage 30. When the windshield is of a foldable type, e.g., with a hinge structure at its lower portion, the windshield can be folded from a first “up” position, secured to the roll cage, to a “down” position engaging retention elements on the hood 20, to allow free flow of air through the interior passenger compartment of the vehicle.

The windshield in another embodiment can be secured in position on the roll cage 30 with a plurality of mounting assemblies of the type shown in FIG. 2, so that the windshield is detachable by simply pulling on the extensible “tongue” portion of the flexural mount device, to disengage it from the mounting bracket associated therewith.

The flexural mount device and mounting bracket components of the mounting assembly of the invention may be provided as components of a retrofit or aftermarket modification kit, for customization of a recreational vehicle to permit ready attachment and detachment of structural articles to the roll cage of the vehicle. Such structural articles may for example include detachable and/or foldable windshields, as described, or spotlights, racks, cases, toolboxes, canopies, water containers, ice chests, and boom boxes. The mounting assemblies of the invention in a further embodiment can be used to secure a stationary structure to the roll cage or frame of the vehicle, such as a tent, tarp or sunscreen, for camping or temporary shelter in off-road terrain.

The mounting assemblies of the invention in a further embodiment can be provided as components of a recreational vehicle retrofit kit that can include a variety of other possible components, e.g., a rear bumper 38 of the type shown at the rear 12 of the vehicle, side doors 32, and/or vehicle top 22, as shown in FIG. 1.

Referring to FIGS. 2-9, the flexural mount device 50 includes a main body portion 52 of first thickness, with front surface 54 and back surface 56, an intermediate portion 58 with front surface 60 and back surface 62, wherein the intermediate portion back surface 62 is substantially coplanar with and extends from the back surface 56 of the main body portion 52, and an end portion 64 with front and back surfaces, the end portion back surface being substantially coplanar with and extending from the back surface of the intermediate portion.

The intermediate and end portions of the flexural mount device have a second thickness smaller than the first thickness, and the intermediate portion is sufficiently flexible so that the end portion can be folded back toward the main body portion, as shown in FIGS. 2 and 6, so that the intermediate portion has an arcuate profile for corresponding circumferential contact with a base structure, e.g., an elongated tubular member. The intermediate portion 58 and end portion 64 of the mounting device include an elongate channel opening therein, and the main body portion is adapted for mechanical fastening of a mountable structure with a mechanical fastener assembly engaging the main body portion and the elongate channel opening.

The mechanical fastener assembly may include a bracket 72, as shown in FIGS. 2 and 7-9, bolted to the main body portion 52. The bracket 72 has an engagement extension 74 projecting inwardly therefrom, intermediate to and equidistant from the bolt holes 76 and 78. The bolt holes 76 and 78 accommodate bolt-type mechanical fasteners for attachment of the bracket to the mount, and optionally to the windshield or other mountable structure. The engagement extension 74 thereby is adapted to engage the elongated channel opening 70 in the intermediate and end portions of the flexural mount device, to frictionally secure the flexural mount device 50 to the roll cage 30, as shown in FIG. 2.

As discussed above, the main body portion 52 may be affixed to the windshield or other mountable structure by use of bolts or other mechanical fasteners that are used for attaching the bracket 72 to the main body portion 52 of the flexural mount device 50. Alternatively, the main body portion of the flexural mount device may be independently secured to the windshield or other mountable structure that is to be mounted to a base structure with the fastening assembly of the invention. Such independent securement may for example include use of additional mechanical fasteners, or other securement means or techniques, such as adhesive bonding, fusion bonding, or the like, to affix the mountable structure to the flexural mount device, so that the mountable structure can be secured on the base structure.

A significant advantage of the flexural mount device of the present invention is that it can be utilized without any modification or alteration of the base structure to which the mountable structure is to be secured. In application to a recreational vehicle of the type exemplified in FIG. 1, this means that the roll cage or frame of the vehicle does not require any drilling, tapping, welding, thread cutting, or other modification, in order to utilize the flexural mount device to secure the mountable structure such as a windshield to the roll cage base structure.

The flexural mount device of the invention is suitably formed of a flexible, resilient material of construction that permits the end portion to be pulled into position when the flexural mount device is wrapped around a base structure, so that the engagement extension of the mounting bracket engages the channel on the flexural mount device, and the end portion of the flexural mount device is tensionally held in position on the base structure.

For such purpose, the end portion and intermediate portion may be extensible, e.g., stretchable, in relation to the main body portion of the flexural mount device. Appropriate materials of construction for the flexural mount device may therefore include high durometer elastomeric materials, such as natural or synthetic rubber or other elastomers. The choice of materials of construction can be made by simple empirical tests involving forming of the flexural mount device of a candidate material, and determining its suitability for securing the mountable structure to the base structure, and its retentive ability to maintain an effective securement of the mountable structure to the base structure in subsequent use.

The flexural mount device may in specific embodiments be formed of a silicone elastomer composition, a polyurethane elastomer composition, perfluorinated elastomers, vinyl rubbers, poly(aromatic vinyl) block copolymers, styrene block copolymers such as styrene-butadiene-styrene block copolymer, styrene-(ethylene-butylene)-styrene block copolymer, styrene-(ethylene-propylene)-styrene block copolymer; and diene rubbers such as styrene-butadiene rubber, butadiene rubber, isoprene rubber, ethylene-propylene rubber (EPM), ethylene-propylene-non-conjugated diene rubber (EPDM), and natural rubber. These materials may also be used in combination of two or more species, as blends, composites, copolymers, etc. The flexural mount device may be constructed of any suitable material having properties rendering the device effective for its intended purpose. In one embodiment, the flexural mount device may be formed of an elastomeric material having a durometer hardness in a range of from 50 to 90, preferably in a range of from about 60 to 80.

The mounting bracket employed in the mounting assembly of the invention may be formed of a suitable metal, such as steel, galvanized steel, chrome steel, brass, aluminum, etc., or other material such as a graphite composite or structural engineering plastic. The mechanical fasteners may be formed of the same materials as the mounting bracket or may alternatively be formed of other metals, alloys, etc.

The invention therefore contemplates a recreational vehicle including a frame structure to which a mountable structure is secured by the flexural mount device of the invention. The mountable structure can be of any suitable type, and may in specific embodiments include spotlights, detachable or foldable windshields, racks, cases, toolboxes, canopies, water containers, ice chests, boom boxes, and a wide variety of other articles and objects that are affixed to the roll cage or other frame structure of the vehicle.

While the invention has been described herein with specific reference to vehicular applications, it will be appreciated that the flexural mount device of the invention and mount assemblies comprising same may be utilized for a wide variety of alternative end-use applications, such as securement of mountable structures to base structures in boats, aircraft, temporary and permanent housing, buildings, and outdoor location applications.

Accordingly, while the invention has been described herein with reference to specific aspects, features and embodiments, it will be appreciated that the invention is not thus limited, but rather extends to and encompasses variations, modifications and alternative embodiments, that will suggest themselves to those of ordinary skill in the art, based on the disclosure herein. The invention is therefore to be correspondingly interpreted and construed, as including all such variations, modifications and alternative embodiments, as being within the spirit and scope of the invention as hereafter claimed.

What is claimed is:

1. A flexural mount device for securing a mountable structure to a base structure, said flexural mount device comprising a main body portion of first thickness, with front and back surfaces, an intermediate portion with front and back surfaces, wherein the intermediate portion back surface is substantially coplanar with and extends from the back surface of the main body portion, and an end portion with front and back surfaces, the end portion back surface being substantially coplanar with and extending from the back surface of the intermediate portion, the intermediate and end portions having a second thickness smaller than the first thickness, the intermediate portion being sufficiently flexible so that the end portion can be folded back toward the main body portion so that the intermediate portion has an arcuate profile for corresponding circumferential contact with the base structure, the intermediate and end portions including an elongate channel opening therein and the main body portion being adapted for fastening of the mountable structure with a fastener assembly engaging the main body portion and the elongate channel opening.

2. The flexural mount device of claim 1, formed of an elastomeric material.

3. The flexural mount device of claim 1, formed of a material selected from the group consisting of silicone elastomers, a polyurethane elastomers, perfluorinated elastomers, vinyl rubbers, poly(aromatic vinyl) block copolymers, styrene block copolymers, styrene-butadiene-styrene block copolymers, styrene-(ethylene-butylene)-styrene block copolymers, styrene-(ethylene-propylene)-styrene block copolymers, diene rubbers, styrene-butadiene rubber, butadiene rubber, isoprene rubber, ethylene-propylene rubber (EPM), ethylene-propylene-non-conjugated diene rubber (EPDM), and natural rubber, and blends, composites and copolymers of monomers of the foregoing.

4. The flexural mount device of claim 1, formed of a material having a durometer hardness in a range of from 50 to 90.

5. The flexural mount device of claim 1, formed of a material having a durometer hardness in a range of from 60 to 80.

6. A mounting assembly comprising a flexural mount device as claimed in claim 1, and a mounting bracket securable to the main body portion of the flexural mount device, in which the mounting bracket includes an extension element that is engageable with the elongate channel opening of the flexural mount device when the flexural mount device is wrapped around a base structure.

7. The mounting assembly of claim 6, wherein the main body portion of the flexural mount device has mounting holes therein, to enable the mounting bracket to be secured to the flexural mount device by mechanical bolt and nut members.

8. The mounting assembly of claim 6, wherein the mounting bracket is secured to the flexural mount device.

9. The mounting assembly of claim 8, wherein the mounting bracket is secured to the flexural mount device by mechanical fasteners.

10. The mounting assembly of claim 8, wherein the mounting bracket is secured to the flexural mount device by bonding thereof to one another.

11. A structural assembly including a mountable structure and a base structure, wherein the mountable structure is secured to the base structure by a flexural mount device as claimed in claim 1.

12. The structural assembly of claim 11, further comprising a mounting bracket secured to the main body portion of the flexural mount device and including an engagement element engageable with the elongate channel opening of the flexural mount device when the flexural mount device is wrapped around the base structure.

13. The structural assembly of claim 12, wherein the base structure comprises a structure selected from the group consisting of vehicular structures, watercraft structures, aircraft structures, building structures, housing structures, and outdoor location structures.

14. The structural assembly of claim 12, wherein the base structure comprises a vehicular structure.

15. The structural assembly of claim 14, wherein the base structure comprises a frame structure of a vehicle.

16. The structural assembly of claim 14, wherein the base structure comprises a roll cage structure of a vehicle.

17. The structural assembly of claim 16, wherein the mountable structure comprises a structure selected from the group consisting of spotlights, windshields, racks, cases, toolboxes, canopies, water containers, ice chests, and boom boxes.

18. The structural assembly of claim 16, wherein the mountable structure comprises a windshield.

19. The structural assembly of claim 16, wherein the mountable structure comprises a foldable windshield.

20. A vehicle including a structural member, and a mountable structure secured to the structural member with a securement assembly including a flexural mount device, said flexural mount device comprising a main body portion of first thickness, with front and back surfaces, an intermediate portion with front and back surfaces, wherein the intermediate portion back surface is substantially coplanar with and extends from the back surface of the main body portion, and an end portion with front and back surfaces, the end portion back surface being substantially coplanar with and extending from the back surface of the intermediate portion, the intermediate and end portions having a second thickness smaller than the first thickness, the intermediate portion being sufficiently flexible so that the end portion can be folded back toward the main body portion so that the intermediate portion has an arcuate profile for corresponding circumferential contact with the structural member, the intermediate and end portions including an elongate channel opening therein and the main body portion being adapted for fastening of the mountable structure with a fastener assembly engaging the main body portion and the elongate channel opening.

21. The vehicle of claim 20, wherein the structural member comprises a frame member of the vehicle.

22. The vehicle of claim 20, wherein the structural member comprises a portion of a roll cage of the vehicle.

23. The vehicle of claim 20, further comprising a mounting bracket securable to the main body portion of the flexural mount device, in which the mounting bracket includes an extension element that is engageable with the elongate channel opening of the flexural mount device when the flexural mount device is wrapped around the structural member.
